(19) United States
(12) Patent Application Publication
(10) Pub. No.: US 2015/0137513 A1
(43) Pub. Date: May 21, 2015

(54) KEYED FITTING

(71) Applicant: Swagelok Company, Solon, OH (US)

(72) Inventors: William H. Glime, III, Chagrin Falls, OH (US); John E. Baxter, Brunswick, OH (US); James G. McCoy, Mayfield Heights, OH (US)

(21) Appl. No.: 14/538,861

(22) Filed: Nov. 12, 2014

Related U.S. Application Data
(60) Provisional application No. 61/907,058, filed on Nov. 21, 2013.

(51) Int. Cl. F16L 37/58

(52) U.S. Cl. CPC F16L 37/58
USPC 285/330

(57) ABSTRACT

A fitting assembly for conduit with a longitudinal axis includes a first fitting component, a second fitting component that can be joined with the first fitting component when the fitting is pulled-up, and a keyed coupling that allows the first fitting component and the second fitting component to be pulled-up.

### RELATED APPLICATION

The present application claims the benefit of pending U.S. Provisional patent application Ser. No. 61/907,058 filed on Nov. 21, 2013 for KEYED FITTING, the entire disclosure of which is fully incorporated herein by reference.

### BACKGROUND

The inventions relate generally to fittings for fluids, for example, gas and liquids. More particularly, the inventions relate to fittings that provide a mechanical connection between mating parts to provide a fluid tight sealed connection.

### SUMMARY

A first inventive concept described herein is a keyed coupling for a fluid fitting assembly, in which the keyed coupling includes two parts that mate with each other in order for the fitting to be made up. In an embodiment, a first part comprises a first geometry and a second part comprises an inverse or mating geometry. If the two parts do not have mating geometries then fitting make-up is inhibited. Additional embodiments are described herein.

A second inventive concept described herein is a keyed coupling for a fluid fitting assembly, in which the keyed coupling includes two parts that are disposed on respective fitting components of the fitting assembly, wherein the two parts mate with each other in order for the fitting components to be made up. In an embodiment, the keyed coupling includes a first flange member installed on a first fitting component and a second flange member installed on a second fitting component. The flange members comprise mating geometries in order for the fitting components to be assembled. If the flange members have non-mating geometries then assembly of the fitting components is inhibited.

The keyed coupling concepts described herein may be used with many different types of fittings for fluids, for example, VCR® type fittings available from Swagelok Company, Solon, Ohio. Many other fluid fitting types may utilize the keyed coupling concepts described herein, for example any fitting that has two components that are joined together to form a mechanical connection between two fluid passages. The fittings may be made of metal or plastics or other materials that are compatible with the system fluid contained by the fitting as well as the pressure, temperature and vibration requirements for the fitting.

### BRIEF DESCRIPTION OF THE DRAWINGS

FIG. 1 is an embodiment of a fitting with a keyed coupling in elevation in a pulled-up position,

FIG. 2 is the fitting assembly of claim 1 in longitudinal section,

FIG. 3 is the fitting assembly of FIG. 2 in a non-pulled up position,

FIG. 4 is another embodiment of a fitting with a keyed coupling in a pulled-up position, shown in longitudinal section,

FIG. 5 is the fitting assembly of FIG. 4 in a non-pulled up position,

FIG. 6 is an example of interfering mismatched parts of a keyed coupling.

### DETAILED DESCRIPTION OF EXEMPLARY EMBODIMENTS

As used herein, the terms fluid fitting, fitting assembly and fitting are used interchangeably, it being understood that the present inventions are directed to mechanical connections for fluid couplings. All references herein to axial and radial and derivatives thereof are referenced to a longitudinal axis X of the fitting unless otherwise noted.

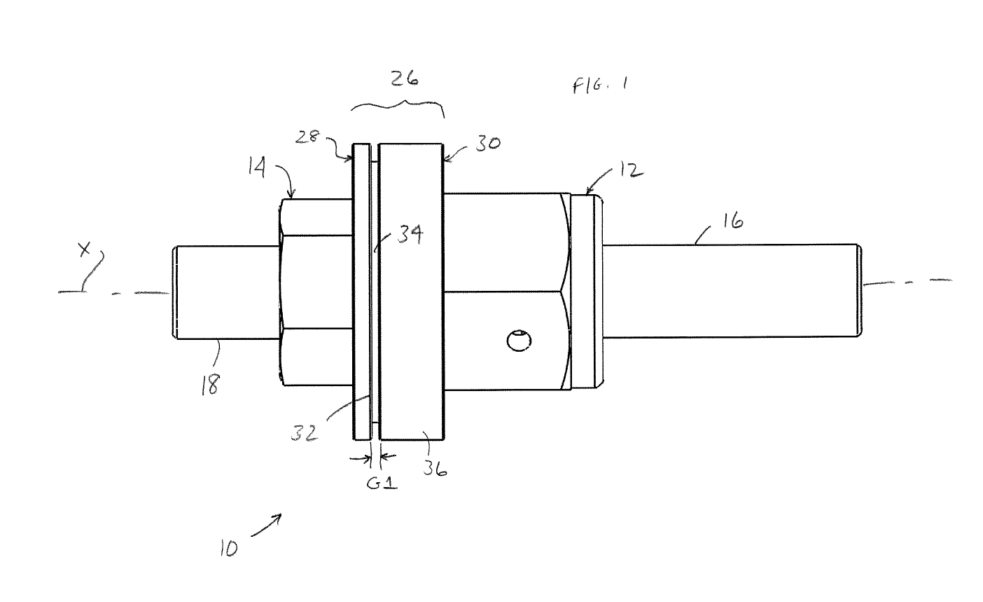

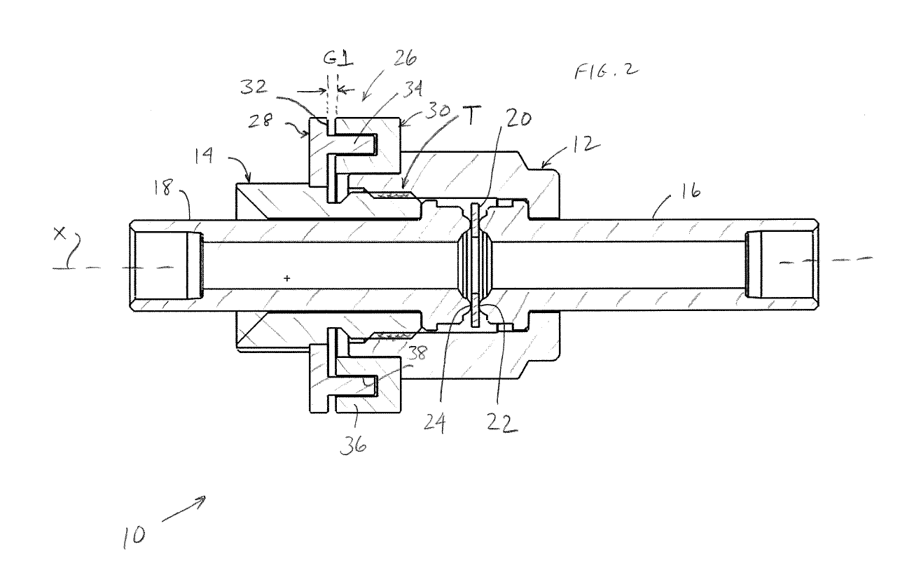

With reference to FIGS. 1 and 2, in an embodiment, a fitting assembly 10 for fluids includes a first fitting component 12 and a second fitting component 14. In the exemplary embodiments herein, the fitting assembly may be realized in the form of a VCR® type fitting, but many other fitting types may alternatively be used, including but not limited to metal and non-metal fittings that utilize threaded and non-threaded mechanical connections.

The fitting 10 is shown in an assembled or pulled-up condition in FIGS. 1 and 2. The first fitting component 12 may be a threaded female nut and the second fitting component 14 may be a threaded male nut to provide a threaded connection T. The fitting 10 is made-up or pulled-up to be a completed connection when the female nut 12 and the male nut 14 are axially joined and tightened together, usually by a prescribed number of turns or partial turns past a finger-tight position, as is well known. A pair of glands 16, 18 that are aligned along a longitudinal axis X (thus the axis X lies along the fluid flow path within the fitting 10) and a gasket 20 that is axially between the glands 16, 18, are axially forced together when the female nut 12 and the male nut 14 are pulled-up. Each gland 16, 18 includes a respective bead 22, 24 that forms a compression face seal against a facing side of the gasket 20. The term pulled-up and derivative terms refers to completing the assembly of the fitting 10 by tightening the female nut 12 and the male nut 14 together to effect a fluid-tight seal.

In accordance with the teachings herein, a keyed coupling 26 is provided that may be used to enable and confirm that the two fitting components 12, 14 can be joined together axially. For example, the keyed coupling 26 may be used to reduce the opportunity to join two fitting components that are connected to different fluid sources or applications.

The keyed coupling 26 may include a first part 28 that is disposed on the first fitting component 12 and a second part 30 that is disposed on the second fitting component 14. For example, the first and second parts 28, 30 may be attached to an outer surface of the respective fitting component 12, 14. The first and second parts 28, 30 may be installed by any suitable technique, for example, a press fit, adhesive or other suitable method. The keyed coupling 26 may be made of materials that are different from the materials used in the fitting components 12, 14. For example, the fitting 10 may use metal parts, but the keyed coupling 26 may be plastic parts, or metal parts or other material as needed. Since the keyed coupling 26 does not need to sustain a high load or stress, plastic materials are well suited for the keyed coupling 26.

In order to allow the keyed coupling 26 to be assembled, the first part 28 and the second part 30 are provided with complementary or mating geometries in order to allow the first part 28 and the second part 30 to mate together when the first part 28 and the second part 30 are axially moved together as the fitting 10 is pulled-up. In this way, a different or third part that does not have a mating geometry will interfere with one of the first part 28 and the second part 30 to inhibit the keyed coupling 26 from being mated, which in turn will inhibit the fitting assembly 10 from being pulled-up.

The first part 28 and the second part 30 of the keyed coupling 26 may be realized, for example, in the form of flange-like members, although many alternative shapes and designs may be used as needed. The first part 28 may include a flange 32 having an annular ring 34 extending in an axially in-board direction therefrom. The second part 30 may include a flange 36 having an annular groove or channel 38 formed therein. The groove 38 geometry is sized and positioned radially and axially to receive the annular ring 34 to allow the first part 28 and the second part 30 to be axially mated together, thereby allowing the first fitting component 12 and the second fitting component 14 to be axially moved together to make up the fitting 10. Viewed another way, the ring 34 and the groove 38 have inverse geometries so that the ring 34 is received in the groove 38 as shown in FIG. 2. Since the ring 34 and the groove 38 are annularly matched, they do not interfere with the rotation of the threaded mechanical connection use to tighten the female nut 12 and the male nut 14 together. The geometries of the keyed parts 28, 30 need not be annularly continuous.

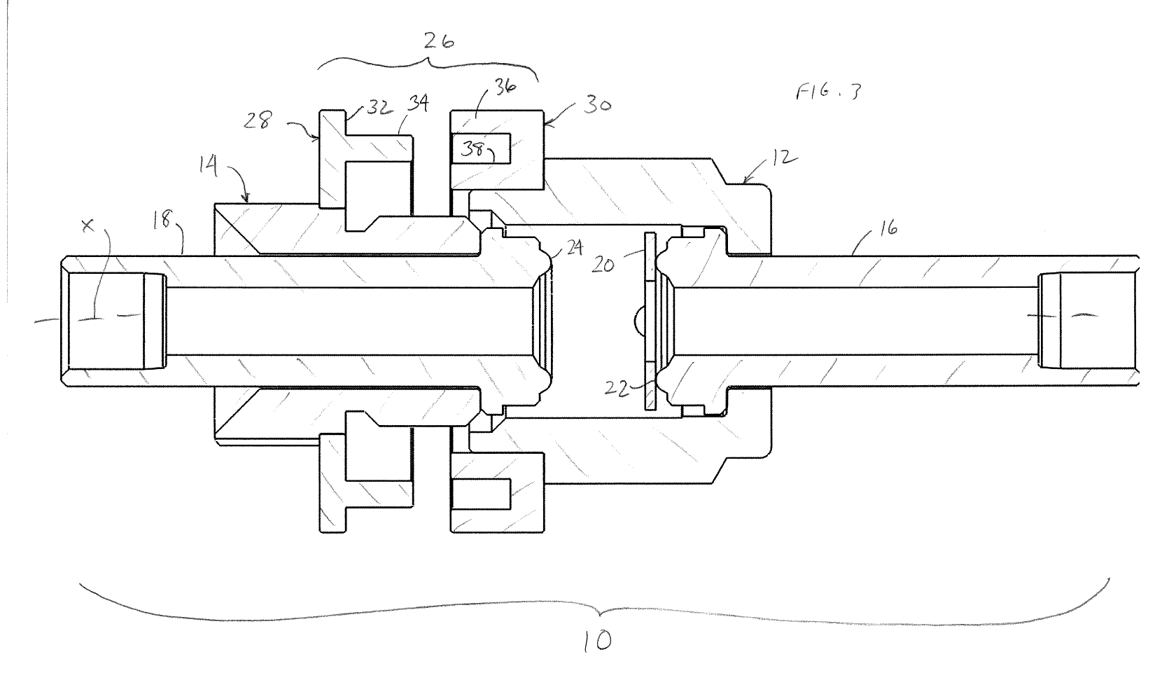

FIG. 3 illustrates the fitting 10 in a loose condition prior to joining the female nut 12 and the male nut 14 together. The keyed coupling concept provides a structure by which the keyed coupling enables the fitting 10 to be pulled-up when the keyed coupling parts have mating geometries and that do not interfere with the normal relative rotation of the nuts 12, 14.

From FIG. 2 it will be noted that there may be an axial gap G1 presented between the first part 28 and the second part 30 after pull-up of the fitting 10. This axial gap may be used to assure that the fitting 10 can be completely pulled-up without the flanges 32, 36 making contact before complete pull-up. Such contact could impose a positive stop to prevent a complete pull-up. However, the gap G1 also provides a structure for an intrinsic gauge feature meaning a gauge feature that is integrated into or made part of the fitting as opposed to the need for a separate gauging tool. The size of the axial gap G1 may alternatively be analyzed with a gap gauge or other gauge device to determine adequate pull-up. In alternative embodiments, optionally the gap G1 may be reduced to zero after a completed pull-up of the fitting 10 in order to provide a positive stop to indicate mechanically and visually a completed pull-up of the fitting 10, or to prevent over-tightening. For embodiments that allow for an axial gap G1>0 after a completed pull-up, remakes are available. As an intrinsic gauge, the axial gap G1 may be used to detect assembly errors. For example, if two gaskets 20 are inserted into the fitting 10, the gap G1 will be larger than compared with the expected gap G1 when a single gasket 20 is installed. If a gasket 20 is omitted, the gap G1 will be smaller, or even go to a positive stop with G1=0, than the expected gap G1 for a single gasket 20.

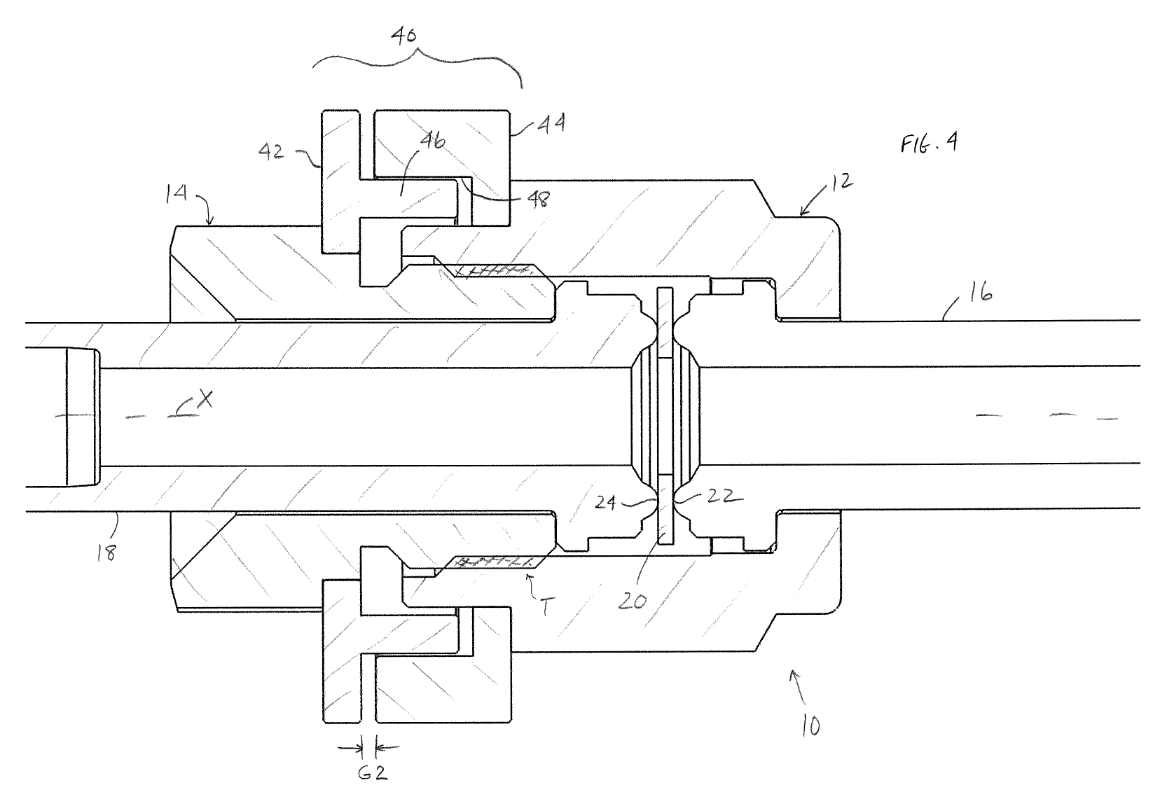

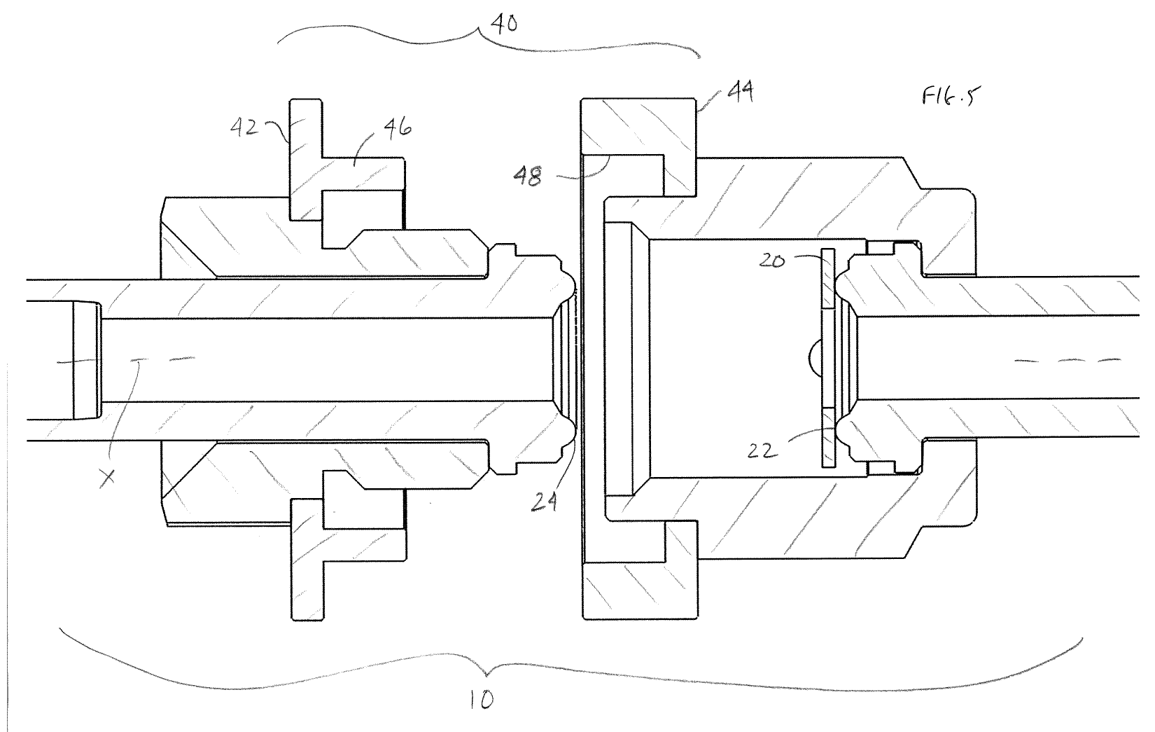

FIGS. 4 and 5 illustrate a second embodiment of a keyed coupling 40. The keyed coupling 40 is again shown in an exemplary assembly with a fitting 10 which need not be described again. The keyed coupling 40 may include a first part 42 and a second part 44. A comparison with the embodiment of FIGS. 2 and 3 shows that the first part 42 has an annular ring 46 having a smaller diameter than the annular ring 34 of the first keyed coupling 26. Consequently, the second part 44 may have an annular groove 46 of mating diameter and geometry to receive the complementary ring 34 so that the first part 42 and the second part 44 have inverse geometries. Operation of the second keyed coupling 40 may be the same as the operation of the first keyed coupling 26.

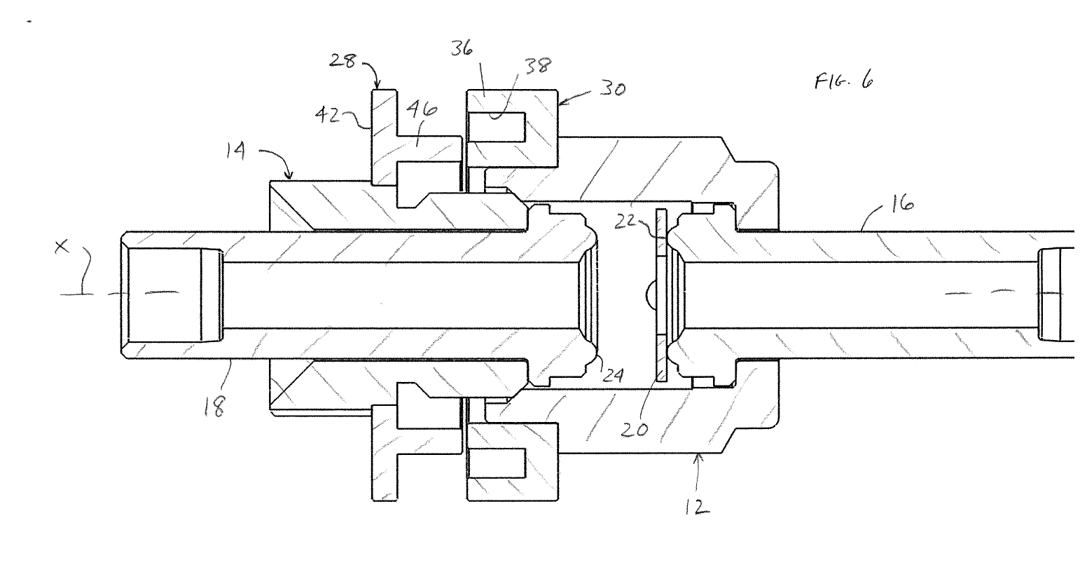

FIG. 6 illustrates another feature of the inventive concepts disclosed herein. Suppose now that a first part 42 of the second keyed coupling 40 (FIG. 4) is attempted to be joined with a second part 30 of the first keyed coupling 26 (FIG. 2). Because the first part 42 does not have a complementary or inverse geometry of the second part 30, there is a mismatch, and the annular ring 46 of the first part 42 will interfere with the second part 30 and cannot be axially mated therewith. This will inhibit pull-up of a fitting having the two mismatched keyed parts 30, 42 because if the keyed coupling parts cannot axially conform, the female nut 12 and the male nut 14 cannot be pulled up.

In addition, a gap G2 will be presented due to the mismatched keyed coupling parts, and this gap G2 will be larger than a gap G1 caused, for example, by having two gaskets installed.

The keyed couplings 26, 40 therefore can be used, along with additional keyed couplings for other fittings, to assist an assembler in verifying that the correct fitting components 12, 14 are assembled together and pulled-up. This can be helpful in systems where there may be many fittings being made-up in close proximity to each other but where the different fittings are used for different purposes, for example, different gases or liquid flow paths.

As an alternative embodiment or as an additional back-up to the keyed coupling concept, the keyed coupling first part and second part may be color coded or include other visual indicia to further indicate which parts mate together.

The use of the keyed coupling concept not only can inhibit unintended connections between fitting components, but also will allow intended connections, will not interfere with rotation of the fitting components during pull-up of threaded connections, and may also be used with conventional fitting component designs.

The geometry of the keyed coupling parts may be widely varied as needed to assure only matching first parts and second parts can be joined together. For example, rather than single ring/groove combinations, multiple ring/groove combinations may alternatively be used. As another alternative, ring thickness (radial dimension) may be used as a variable between different keyed couplings.

As another alternative, rather than using a discrete first part and second part for the keyed coupling, the keyed parts may be integrally machined or formed into the fitting components.

1. A fitting assembly for conduit with a longitudinal axis, comprising:
a first fitting component,
a second fitting component that can be joined with said first fitting component when the fitting is pulled-up,
a keyed coupling that allows said first fitting component and said second fitting component to be pulled-up.

2. The fitting assembly of claim 1 wherein said keyed coupling comprises a first part and a second part that must have mating geometries to allow axial movement of said first fitting component and said second fitting component to a pulled-up position.
